(19) United States
(12) Patent Application Publication
(10) Pub. No.: US 2021/0359572 A1
(43) Pub. Date: Nov. 18, 2021

(54) ELECTRIC MOTOR CONTACT ADAPTER

(71) Applicant: Brose Fahrzeugteile SE & Co. Kommanditgesellschaft, Würzburg, Würzburg (DE)

(72) Inventors: Joseph SURIANO, Grand Blanc, MI (US); Peter HAUCK, Gerbrunn (DE); Christoph EHEHALT, Würzburg (DE)

(73) Assignee: Brose Fahrzeugteile SE & Co. Kommanditgesellschaft, Würzburg, Würzburg (DE)

(21) Appl. No.: 16/874,363

(22) Filed: May 14, 2020

(51) Int. Cl. H02K 5/22; H02K 3/52; H02K 5/15; H02K 15/00; H01R 39/02

(52) U.S. Cl. CPC H02K 5/225; H02K 3/522; H02K 2203/09; H02K 15/0062; H01R 39/02; H02K 5/15

(57) ABSTRACT

A housing may include a first end that may define a first aperture. The stator may be disposed in the housing and include a bus bar that may extend towards the first aperture. The contact adapter may be fixed to the first end of the housing and may include a base member and a contact member. The base member may define a contact aperture and may include a body and a collar that may extend from the body. The body and the collar may define a pocket and the contact aperture may be disposed in the pocket. The contact member may include a first end, a second end, and a medial portion extending therebetween. The first end may extend from the body into the pocket and may contact the bus bar. The second end may extend from the base member and may be configured to contact an electrical connector.

### TECHNICAL FIELD

### The present disclosure relates to an electric motor such as an electric motor for use in motor vehicles.

### BACKGROUND

Vehicles may include a number of electric motors, such as a motor to actuate a window, a vehicle brake, or a steering mechanism. The motors may include a stator, a rotor and a motor shaft that mounts the stator or the rotor. Power may be supplied to the motor via a connection plug that may be electrically connected to windings of the stator.

### SUMMARY

According to one embodiment, an electric motor is provided. The electric motor may include a housing, a stator, and a contact adapter. The housing may include a first end that may define a first aperture. The stator may be disposed in the housing and include a bus bar that may extend towards the first aperture. The contact adapter may be fixed to the first end of the housing and may include a base member and a contact member. The base member may define a contact aperture and may include a body and a collar that may extend from the body. The body and the collar may define a pocket and the contact aperture may be disposed in the pocket. The contact member may include a first end, a second end, and a medial portion extending therebetween. The first end may extend from the body into the pocket and may contact the bus bar. The second end may extend from the base member and may be configured to contact an electrical connector.

According to another embodiment, an electric motor is provided. The electric motor may include a housing, a stator, and a contact adapter. The housing may extend in an axial direction and may include a first end that may define a recess having an inner periphery. The first end may further define an aperture that may be disposed in the recess. The stator may be disposed in the housing and include a bus bar that may extend towards the first aperture. The contact adapter may be disposed in the recess and may include a base member and a contact member. The base member may include a body that may define a contact aperture. The contact member may include a first end, a second end, and a medial portion extending therebetween. The first end may extend from the body into the contact aperture and contact the bus bar. An outer periphery of the body may engage the inner periphery of the recess to fix the contact adapter in a radial direction.

According to yet another embodiment, a method of assembling an electric motor is provided. The electric motor may include a housing that may be provided with a first end that may define a recess having an inner periphery. The first end may further define an aperture that may be disposed within the recess. The motor may also include a bus bar disposed within the housing and extending towards the recess. The method may include inserting contact adapter provided with a plurality of deformable ribs into the recess so that the deformable ribs plastically deform.

### BRIEF DESCRIPTION OF THE DRAWINGS

FIG. 1 illustrates an exploded-perspective view of an exemplary electric motor.

FIG. 2 illustrates a perspective view of an exemplary contact adapter.

FIG. 3 illustrates a perspective view of another exemplary contact adapter.

FIG. 4 illustrates a bottom-perspective view of the exemplary contact adapter illustrated in FIG. 2.

FIG. 5 illustrates a top-perspective view of the exemplary motor illustrated in FIG. 1.

FIG. 6 illustrates a detailed-perspective view of the exemplary contact adapter.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The term “deform” or “deformable” may be used herein to describe disclosed or claimed embodiments. The term “deform” or “deformable” may refer to a permanent distortion, such as plastic deformation that occurs when a material is subjected to tensile, compressive, bending, or torsion stresses that exceed its yield strength and cause it to elongate, compress, buckle, bend, or twist. The term “deform” or “deformable” may also refer to a temporary shape change that is self-reversing after the force is removed, so that the object returns to its original shape.

Electric motors, such as brushless electric motors are generally connected to a printed circuit board adapter (PCBA) by a wire harness to a contact adapter fixed to the motor. Contact adapters include electrical connections extending between a component of the electric motor, such as a stator or a rotor, to the contact adapter. One of the challenges associated with known contact adapters is protecting or shielding the electrical connections prior to assembling the wire harness or other connecting device to the contact adapter. Failing to protect the contact adapter may result in damage to the electrical contacts during assembly or in transit. Known contact adapters may require a cover that may create additional costs. Or other known contact adapters may not provide any protection at all.

Fixing the contact adapter to the motor housing or other suitable motor component may present other challenges. As an example, known contact adapters may be fixed to the motor by one or more fasteners. As another example, known contact adapters may include one or more welds between the electric connections of the contact adapter and electric connections of the motor. Welding requires sufficient access for fixturing and a welding tool.

Referring generally to the figures, an electric motor 100 is provided. The electric motor 100 may include a housing 102 that may extend in an axial direction A. The housing may include a first end 104 and a second end 106. In one or more embodiments, the first end 104 may be formed by a bearing shield 108. The first end 104, such as the bearing shield 108, may define a recess 110. The bearing shield 108 may define an aperture 112 that may be disposed in the recess 110. The electric motor 100 may include a stator 114 that may be disposed in the housing 102. The stator 114 may include a number of bus bars 116 that may extend from the stator 114 to the aperture 112.

The electric motor 100 may include a contact adapter 118 that may be configured to provide an electric connection between the stator and a power source through a PCBA. The contact adapter 118 may be disposed within the recess 110 and may include a base member 120 and a contact member 122. The base member 120 may include a body 124 that may define a contact aperture 126. The contact member 122 may include a first end 128, a second end 130, and a medial portion 132 extending therebetween. The first end 128 of the contact member 122 may extend from the body into the contact aperture 126 to engage the bus bar 116. An outer periphery 134 of the body 124 may be sized to engage an inner periphery 136 of the recess 110. As an example, the outer periphery 134 of the body 124 may engage the inner periphery 136 of the recess 110 so that the contact adapter 118 is radially fixed or fixed in a radial direction. Radial direction may refer to any direction that is orthogonal or transverse to the axial direction A.

The outer periphery 134 of the body 124 may include a plurality of ribs such as deformable ribs 138 that may me be configured to plastically deform as the contact adapter 118 is inserted into the recess 110 of the bearing shield 108. The outer periphery 134 of the body 124 may be formed by a first pair of sidewalls 140 and a second pair of sidewalls 142 that may extend between the first pair of sidewalls 140. As an example, the first pair of sidewalls 140 may have a first length L1 and the second pair of sidewalls 142 may have a second length L2 that may be less than the first length L1. As an example, a number of the deformable ribs 138 may be disposed on or extend from at least one sidewall of the second pair of sidewalls 142.

The base member 120 may include a protrusion 144 that may extend from the body 124 of the contact adapter 118. As an example, the second end 130 of the contact member 122 may extend through the protrusion 144. The first end 128 of the contact member may include first electric contacts 148 and the second end 130 may include second electric contacts 150. The second electric contacts 150 may be spaced apart, in a first direction D1, from the first electric contacts 148. The second electric contacts 150 may be interstitially arranged with respect to each of the first electrical contacts 148 in a second direction D2, that may be substantially orthogonal to the first direction D1.

In one or more embodiments, the contact adapter 118 may include a collar 152 that may extend from the body 124. The collar 152 and the body 124 may define a pocket 154 and the contact aperture 126 may be disposed within the pocket 154. The collar 152 may shield or protect one or more portions of the contact member from inadvertent contact or other extraneous forces applied to the motor 100.

The collar 152 may include a first sidewall 156 and a second sidewall 158. The second sidewall 158 may extend between the first sidewall 156 and the body 124. The second sidewall 158 may be tapered to provide access to the first electrical contacts 148 and the bus bars 116. As an example, the tooling may include a tool used to engage and push the first electrical contacts 148 to the bus bar 116. As another example, the tool may be a welding device, such as a laser welding head or a resistance welding head. The second sidewall 158 may include a base portion 160 and a distal end 162, the base portion 160 may have a first width W1 and the distal end 162 may have a second width W2, that may be less than the first width W1. The first sidewall 156 may be arranged with respect to the first end 128 of the contact member 122 so that the contact aperture 126 is disposed between the first sidewall 156 and the first end 128.

The collar 152 may include a third sidewall 164 that may extend from the body 124 in the second direction D2. Each of the first and second sidewalls 156, 158 may extend from the third sidewall 164 in a third direction D3 that may be substantially orthogonal to the first direction. The third sidewall 164 may be integrally formed with the body 124 and may define the contact aperture 126. In other embodiments, the collar 152 may not include the third sidewall 164 so that the contact aperture 126 is formed by the first and second sidewalls 156, 158 in conjunction with the body 124.

In one or more embodiments, the bus bar 116 may be fixed to the first end 128 of the contact member 122 so that the contact adapter 118 is fixed in the axial direction A. As an example, the bus bar 116 may be fixed to the first end 128 of the contact member 122 by one or more welds. The welds may be a resistance weld applied by resistance welding that may include joining of metals by applying pressure and passing current for a predetermined length of time to the metal area that is to be joined. The welds may also be applied by laser welding that may include the use of a laser to provide a concentrated heat source to metals that are to be joined.

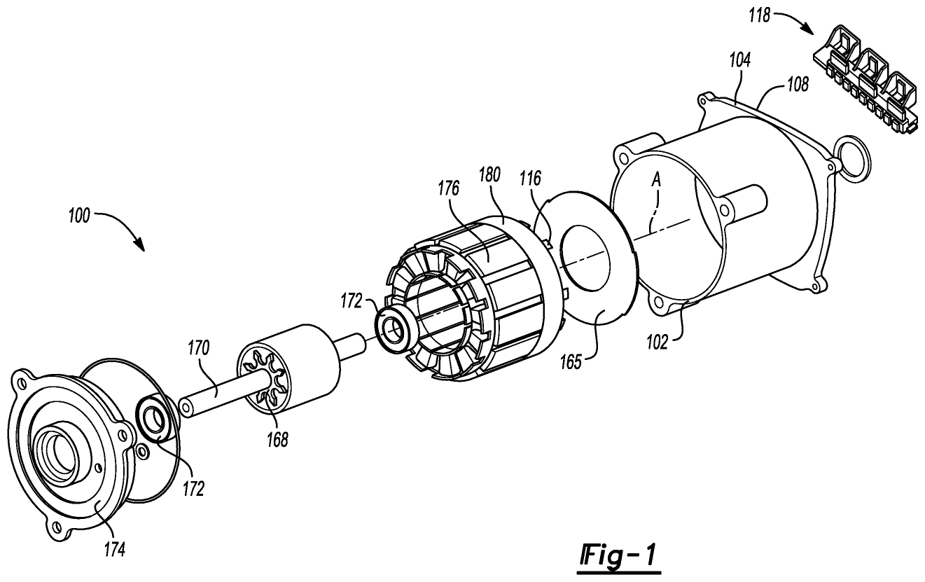

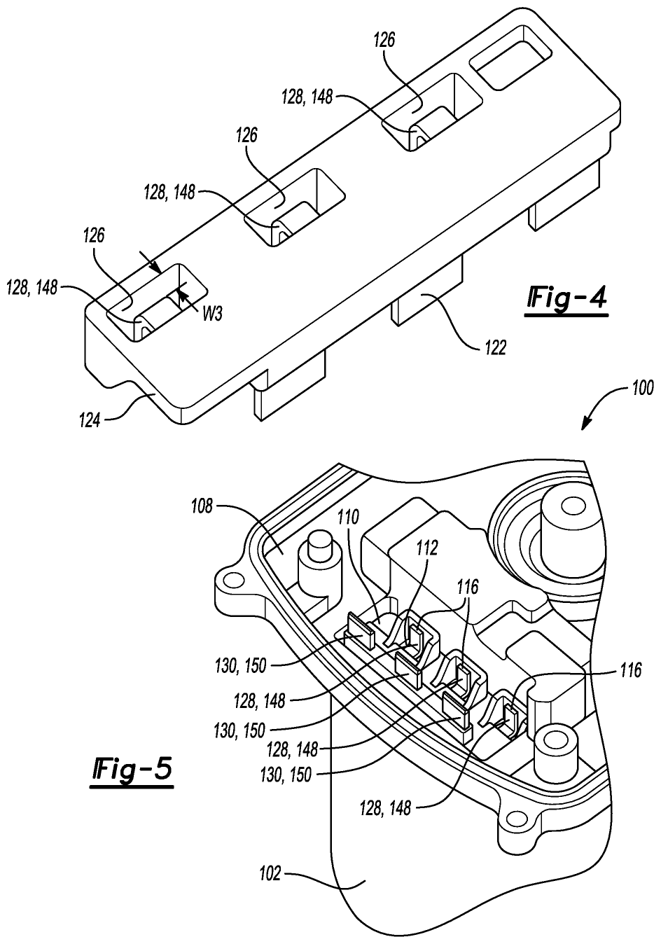

Referring to FIG. 1, an exploded view of an exemplary electric motor 100 is illustrated. The electric motor 100 may include the housing 102 having the first end 104 and the second end 106. As mentioned above the housing may extend along the axial direction A, represented by the dashed line. The second end 106 may define an opening that receives various components of the electric motor 100. The first end 104 may include the bearing shield 108 that may receive the contact adapter 118. As an example, the first end may be formed by a heat sink or other end member, rather than a bearing shield. The motor 100 may include the stator 114 that may sandwich an insulative paper 165 between the stator and the bearing shield 108. The stator 114 may include a number of magnets 176 and a number of windings 178. The windings 178 may be electrically connected to the bus bars 116. The bus bars 116 may extend from a connection unit 180 that may be disposed on one end of the stator 114. One or more of the bus bars 116 may extend towards or into the apertures 112 (FIG. 4) defined by the bearing shield 108.

The stator 114 may receive a rotor assembly 168 provided with a shaft 170. The shaft 170 may be inserted through a ball bearing 172 that may engage the bearing shield 108. Another ball bearing 172 may be disposed on another portion of the shaft and the ball bearing 172 may be received by a second bearing shield 174. The second bearing shield 174 may be fixed to the second end 106 of the housing 102.

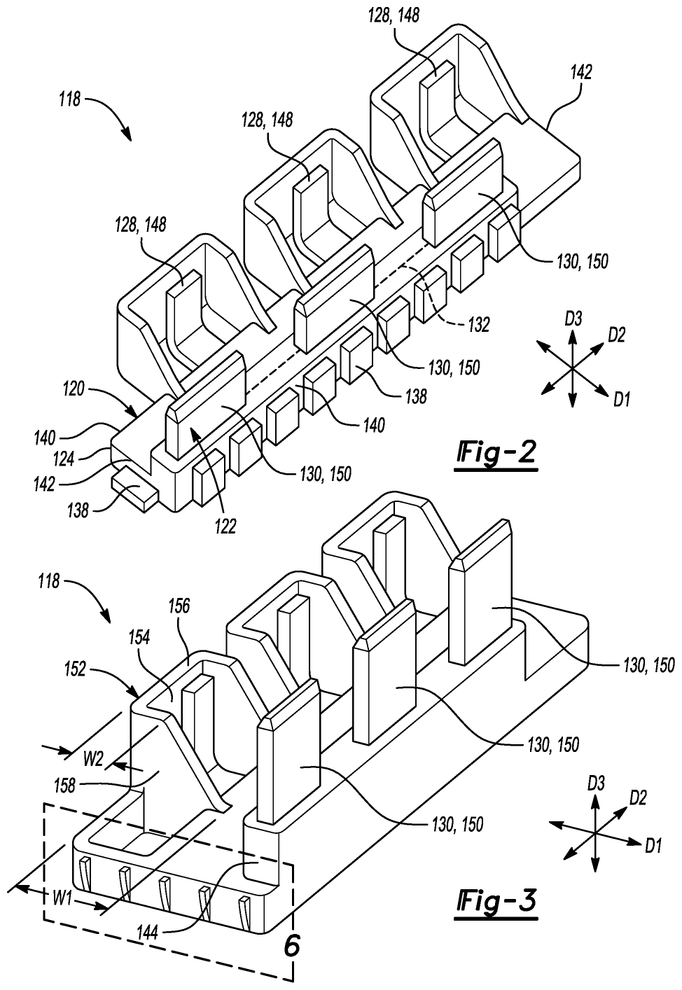

Referring to FIG. 2, a perspective view of an exemplary contact adapter 118 is illustrated. The contact adapter 118 may include a base member 120 that may include a body 124 and a contact member 122. The body 124 may include the first pair of sidewalls 140 that may extend in the first direction D2. The second pair of sidewalls 142 may each extend in the second direction D2 between each of the first sidewalls 140. The contact member 122 may include the first end 128 that may form the first electric contacts 148 and the second end 130 that may form the second electric contacts 150. The first end 128 and the second end 130 may be connected to each other by the medial portion 132 as represented by dashed lines in the body 124. The first end 128 of the contact member 122 may be positioned next to or adjacent to the contact aperture 126.

One or more of the sidewalls 140, 142 may include one or more ribs, such as deformable ribs 138. The deformable ribs 138 may each be integrally formed to the body 124 and may be configured to deform as the contact adapter 118 is inserted into a portion of the housing 102, such as the recess 110. As an example, one or more of the deformable ribs may have a substantially square shape. A distal portion of one of the deformable ribs 138, may have a larger cross-sectional area than that of a proximal portion, disposed between the distal portion of the deformable rib 138 and the body 120.

The body 124 may be formed of a polymeric material, such as thermoplastic, thermoset plastics, or other polymers. As an example, the body 124 may be formed of polybutylene terephthalate (PBT) that may include a predetermined amount of glass-filled fibers that may range between 15% and 45%. In one or more embodiments, portions of the base member 120 or the body 124 may be over molded over the contact member 122. As another example, the body 124 or the base member may be mechanically fixed to the contact member 122 by a mechanical lock, e.g., press-fit condition formed by recesses or tabs or other suitable configurations.

The contact member 122 may be formed by a conductive material such as a metal or alloy. As an example, the contact member 122 may be formed of copper that may be bent, or stamped, or both to a predetermined size and shape.

Referring to FIG. 3, an exemplary contact adapter 118 according to one or more embodiments of the present disclosure is provided. The contact adapter 118 may include the collar 152 that may extend from the body 124 so that the collar 152 and the body 124 form the pocket 154. The collar 152 may include the first sidewall 156 and the second sidewall 158 each of which may at least partially form the pocket 154. The second sidewall 158 may extend between the first sidewall 156 and the body 124. The third sidewall 164 may extend from the body 124 to the first sidewall 156 and may define the contact aperture 126 (FIG. 5).

The collar 152 may also include a fourth sidewall 166 that may extend in the third direction D3. In one or more embodiments, at least one of the second and fourth sidewalls 158, 166 may be tapered to facilitate connection between the contact adapter 118 and the PCBA. As an example, a base portion of the second and fourth sidewalls 158, 166 may have a width W1 and a distal end of the second and fourth sidewalls 158, 166 may have a width W2 that may be less than the width W1.

The body 124 may include a protrusion 144 that may extend in the third direction D3. The second end 130 of the contact member 122 may extend from the protrusion 144.

FIG. 4 illustrates a bottom-perspective view of the contact adapter 118 illustrated in FIG. 3. In one or more embodiments, the body 124 may have an elongated shape, having a length that is greater than a width of the body 124. As previously mentioned, the body 124 may define a number of contact apertures 126 that may be spaced apart from the protrusion 144. A space may be disposed between an edge of the contact aperture 126 and the first end 128 or first electrical contact 148 of the contact member 122. The space may have a width W3 that may be sized to received at least a portion of one or more bus bars 116.

FIG. 5 illustrates a perspective view of the motor 100. As described above, the motor 100 may include the motor housing 102 that may be coupled to a bearing shield 108. The bearing shield 108 may include the recess 110 that may receive the contact adapter 118. Bus bars 116 may extend through recesses defined by the bearing shield 108. When the contact adapter 118 is installed or fixed to the bearing shield 108, the first end 128 of the contact member 122 may engage each of the bus bars 116.

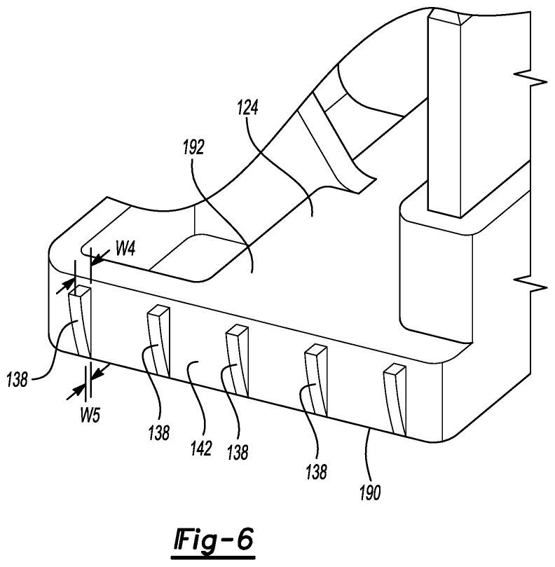

FIG. 6 illustrates a detailed-perspective view of the contact adapter 118. The body 124 may include a bottom portion 190 and a top portion 192. The deformable ribs 138 may be tapered between the bottom portion 190 and the top portion 192. As an example, a portion of the deformable rib 138 may be spaced apart from a top portion sidewall 142 by a distance W4 and another portion of the deformable rib 138 may be spaced apart from the bottom portion 190 by a distance W5. The distance W5 may be less than the distance W4.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

100 electric motor

102 housing

104 first end

106 second end

(108 bearing shield

110 recess

112 aperture

114 stator

116 bus bar

118 contact adapter

120 base member

122 contact member

124 body

126 contact aperture

128 first end

130 second end

132 medial portion

134 outer periphery

136 inner periphery

138 deformable ribs

140 sidewalls

142 sidewalls

144 protrusion

148 first electrical contacts

148 first electric contacts

150 second electric contacts

152 collar

154 pocket

156 first sidewall

158 second sidewall

160 base portion

162 distal end

164 third sidewall

166 fourth sidewall

165 insulative paper

166 fourth sidewalls

168 rotor assembly

170 shaft

172 ball bearing

174 second bearing shield

176 magnets

178 windings

180 connection unit

190 bottom portion

192 top portion

What is claimed is:

1. An electric motor comprising:
a housing including a first end defining a first aperture;
a stator disposed in the housing and including a bus bar extending towards the first aperture; and
a contact adapter fixed to the first end and including,
a base member defining a contact aperture and including a body and a collar extending from the body, wherein the body and the collar define a pocket, wherein the contact aperture is disposed in the pocket, and
a contact member including a first end, a second end, and a medial portion extending therebetween, wherein the first end extends from the body into the pocket and contacts the bus bar, and wherein the second end extends from the base member and is configured to contact an electrical connector.

2. The electric motor of claim 1, wherein the collar includes a first sidewall and a second sidewall extending between the body and the first sidewall, wherein the first sidewall includes a base portion and a distal end, wherein the base portion has a first width and the distal end has a second width, less than the first width.

3. The electric motor of claim 2, wherein the contact aperture is disposed between the first sidewall and the first end of the contact member.

4. The electric motor of claim 3, wherein the collar includes a third sidewall extending in a first direction from the body, wherein the first and second sidewalls each extend from the third sidewall in a second direction, different than the first direction.

5. The electric motor of claim 4, wherein the second direction is substantially orthogonal to the first direction.

6. The electric motor of claim 4, wherein the third sidewall is integrally formed to the body.

7. The electric motor of claim 6, wherein the third sidewall defines the contact aperture.

8. The electric motor of claim 1, wherein the first end is welded to the bus bar.

9. An electric motor comprising:
a housing extending in an axial direction including a first end defining a recess having an inner periphery, and the first end further defining an aperture disposed within the recess;
a stator disposed in the housing and including a bus bar extending from the stator towards the aperture; and
a contact adapter disposed in the recess and including,
a base member including a body defining a contact aperture, and
a contact member including a first end, a second end, and a medial portion extending therebetween, wherein the first end extends from the body into the contact aperture and contacts the bus bar, and wherein an outer periphery of the body engages the inner periphery of the recess to fix the contact adapter in a radial direction.

10. The electric motor of claim 9, wherein the outer periphery of the body includes a plurality of deformable ribs, wherein the each of the deformable ribs are configured to plastically deform as the contact adapter is inserted into the recess.

11. The electric motor of claim 10, wherein the outer periphery of the body is formed by a first pair of sidewalls and a second pair of sidewalls, extending between the first pair of sidewalls, wherein the first pair of sidewalls have a first length and the second pair of sidewalls have a second length, less than the first.

12. The electric motor of claim 11, wherein the plurality of deformable ribs extends from at least one of the sidewalls of the second pair of sidewalls.

13. The electric motor of claim 12, wherein at least one deformable rib of the plurality of deformable ribs is tapered between a bottom portion of the body and a top portion of the body.

14. The electric motor of claim 13, wherein the at least one deformable rib includes a first end and a second end, wherein the first end is spaced apart from a sidewall of the first pair of sidewalls or a sidewall of the second pair of sidewalls, or both, by a first distance and the second end is spaced apart from the sidewall of the first pair of sidewalls or a sidewall of the second pair of sidewalls, or both, by a second distance, wherein the first distance is greater than the second distance.

15. The electric motor of claim 9, wherein the base member includes a protrusion extending from the body, wherein the second end of the contact member extends through the protrusion.

16. The electric motor of claim 9, wherein the first end of the contact member is formed by a number of first electric contacts and the second end is formed by a number of second electric contacts, wherein each of the second electrical contacts are spaced apart in a first direction from each of the first electric contacts and are arranged interstitially with respect to each of the first electrical contacts in a second direction, substantially orthogonal to the first direction.

17. A method of assembling an electric motor including a housing provided with a first end defining a recess having an inner periphery, wherein the first end further defines an aperture disposed within the recess, and a bus bar extending towards the recess, the method comprising:
inserting a contact adapter provided with a plurality of deformable ribs into the recess so that the deformable ribs plastically deform.

18. The method of claim 18, further comprising fixing a contact member disposed within the contact adapter to the bus bar.

19. The method of claim 18, wherein the welding step includes laser welding a first end portion of the contact member to the bus bar.

20. The method of claim 18, wherein the welding step includes resistance welding a first end portion of the contact member to the bus bar.
